(19) United States
(12) Patent Application Publication
(10) Pub. No.: US 2026/0346062 A1
(43) Pub. Date: Nov. 5, 2026

(54) DWELLING PROTECTION SYSTEM FOR WILDFIRE CONDITIONS

(71) Applicant: Alexander Mariasov, Las Vegas, NV (US)

(72) Inventor: Alexander Mariasov, Las Vegas, NV (US)

(21) Appl. No.: 19/195,787

(22) Filed: May 1, 2025

(51) Int. Cl. A62C 2/24

(52) U.S. Cl. CPC A62C 2/247

(57) ABSTRACT

Extensive loss of dwellings due to widespread conflagration is not a new phenomenon. But many believe that the effects of climate change are exacerbating the situation causing more and more-damaging wildfire events. Currently, many dwellings have replacement values of hundreds of thousands of dollars up to millions of dollars. Houses often flare up due to combustible roofs, decks and siding assaulted by glowing, wind-driven sparks. This invention detects a fire risk and enshrouds a dwelling with fire-resistant curtains. Sparks landing on those curtains are far more likely to burn out, harmlessly, than to cause ignition.

### TECHNICAL FIELD

The invention is a protection system for protecting dwellings under wildfire conditions.

### BACKGROUND OF INVENTION

For at least the last two decades, the incidence of out-of-control wildfires in all areas of the United States has been exacerbated by global climate change. The devastating wildfire that affected Pacific Palisades, in Los Angeles, was made worse by adverse wind conditions coupled with lower than average rainfall totals. As a result, dwellings worth millions of dollars each were destroyed as the wildfire swept through the whole neighborhood.

In the aftermath of the destructive fire, it was found that in the midst of burned down dwellings, an odd dwelling would be largely undamaged. It was found that extended distance between a dwelling and burning trees or houses, plus use of fire-resistant roofing, decking, and siding materials helped protect against extensive damage.

Most of the dwellings that were burned ignited due to sparks from other burning dwellings or foliage dropping onto roofs and/or decks. Entire streets and cul-de-sacs were completely burned out as wind-swept sparks coupled with high air temperatures caused a critical mass of burning houses and trees that firefighters were unable to quell.

Had many dwellings been tented by fire-resistant materials kept cooled by water flow, it is believed that many more dwellings would have survived.

### BRIEF DESCRIPTION OF THE INVENTION

The risk of wildfire damage in many areas of the United States has prompted home insurance companies to cancel or increase substantially the premiums for house-insurance coverage.

Years ago, it was found that despite seat belts and harnesses, when vehicles were involved in high-speed accidents, drivers and passengers were still injured severely despite restraints. This led to adoption of so-called “air bag” subsystems whereby when a vehicle is detected to have collided with another vehicle or obstruction, an air bag is deployed providing added protection against driver or passenger impact with windshields or dashboards.

These air bag systems sit quiescently until an emergency is detected, then they are instantly deployed. They are not designed to be reusable, or to be deployed to test their readiness. Virtually every vehicle self-tests air bag readiness each time the car is turned on. A dashboard warning alerts a driver if there is one or more faulty air bags.

In a similar way, the invention herein disclosed is meant to be installed, and remain quiescent until an impending fire danger is detected. Then it is quickly deployed to cover a dwelling on all sides and roof with fire-resistant curtains kept cooled with water circulation.

The curtain material, itself, is perforated to allow some air flow through it and reduce pressure due to high wind when deployed. The water flow has two purposes: it keeps the curtain temperature well below ignition levels, and cools the air flow of high-temperature air as it passes through the curtains.

Just as air bags are essentially hidden from view until required, the invention herein is intended to be minimally apparent until required. Self-testing of all subsystems helps alert occupants, at home or away, if there is any faulty subsystem in need of attention.

Telescoping vertical support subsystems are set up at each of four corners of a rectangle such that a dwelling and all its outer attachments (e.g decks) are within the rectangle, The invention is constantly monitoring smoke and air temperature against predetermined upper limits. So long as smoke and air temperature are below those limits, it remains vigilant and poised but is not set in operation. A manual override subsystem can provide a means to initiate operation in the event that a user wants to deploy the system, sooner.

Telescoping vertical support subsystems are set up at each of four corners of a rectangle such that a dwelling and all its outer attachments (e.g decks) are within the rectangle, The invention is constantly monitoring smoke and air temperature against predetermined upper limits. So long as smoke and air temperature are below those limits, it remains vigilant and poised but is not set in operation. A manual override subsystem can provide a means to initiate operation in the event that a user wants to deploy the system, sooner.

Afterward, a deployment subsystem for the rear/roof/front curtain is activated to pull its horizontal beam top portion first up, then over, and then down. This operation results in full covering of sides, rear, roof and front. Lastly, a valve-control command opens one or more valves that allow water to flow into the side curtains and the rear/roof/front curtain.

Prior to system deployment, the quiescent system may be set up such that the horizontal beam subsystems and the tops of the vertical support subsystems are at or near ground level. In that case, a fixed, lower, section of the telescoping support is located such that almost all of it is buried and fixed underground while a small length is exposed above ground. In another embodiment, the fixed telescoping section may be mounted above ground. Both embodiments are equally effective in providing protection of the dwelling, but there may be a difference in cost. For example, the buried fixed section may require an additional telescoping section compared to the embodiment where the fixed section is above ground. Embodiment choice may be a matter of aesthetics and budget.

Like an air bag, the system is meant to be deployed in an emergency. Its subsystems for raising the support systems and deploying the curtains, and its control system, are optimized for early detection and timely deployment. It is not optimized for returning the system to pre-deployment status, although, it could be used to reverse the deployment process by first rerolling the curtains in their respective horizontal beam subsystems and lowering the support systems to retracted-height positions.

The curtains may have zippered entry portals that would allow someone to enter or leave the dwelling while still boxed in.

### BRIEF DESCRIPTION OF THE DRAWINGS

FIG. 1 shows an exemplary view of the vertical support subsystems, and horizontal beam subsystems forming a rectangular space with the dwelling contained within.

FIG. 2 shows an exemplary view of the side fire-resistant curtains and rear/roof/front fire-resistant curtain wherein the side curtains are fully deployed and the rear/roof/front curtain is being deployed.

FIG. 3 shows an exemplary view of the containment of the house when all fire-resistant curtains are deployed.

FIG. 4a shows an exemplary view of one vertical support in fully lowered orientation.

FIG. 4b shows an exemplary view of the same vertical support in fully raised orientation.

FIG. 5 shows an exemplary view wherein the vertical support subsystems are essentially buried, when not deployed, and only a small portion is above ground.

FIG. 6 shows an exemplary view wherein the vertical support subsystems are fixed in position above ground.

FIG. 7 shows an exemplary view the vertical support systems fully extended.

FIG. 8 shows an exemplary view of the horizontal beam subsystems showing the upper and lower portions, the curtains, and internal roller upon which the curtains are rolled up before deployment.

FIG. 9 is an exemplary view of the system showing the side curtains automatically deployed as the vertical supports are being raised.

FIG. 10 is an exemplary view of the system deploying the rear/roof/front curtain once the supports are fully extended.

FIG. 11 show an exemplary view of an embodiment of the system and its subsystems.

FIG. 12 is a flow diagram showing an exemplary sequence of method steps that underlie system operation.

### DETAILED DESCRIPTION OF THE INVENTION

The invention is a dwelling protection system operative to encompass a dwelling in advance of a detected, proximate, blaze condition.

The system is monitoring smoke and air-temperature levels, comparing them to predetermined control-initiation levels, and if levels are exceeded, the system operates so as to contain all dwelling sides and roof within a rectangular box with fire-resistant faces. Once installed and initialized, the system is in continuous vigilance mode. A manual override subsystem offers a way to initiate operation by the user.

The fire-resistant faces are made of fire-resistant materials and operative to allow water to flow within so as to keep it cooled. The materials faces are perforated to allow air to flow between dwelling and areas outside the fire-resistant surfaces, and the water flow within the faces helps to cool fire-heated air, swept by wind, as it penetrates the faces and moves toward the dwelling.

The fire-resistant material is called a “curtain,” and the system has separate curtains to protect each side, and to protect rear/roof/front of dwelling. The three curtains are initially rolled up onto rollers, each within one of three horizontal beam subsystems.

Two side horizontal beam subsystems are fixed mounted near the bottoms of the vertical support systems. The rear horizontal beam subsystem is fixed mounted near the bottoms to the two rear vertical support subsystems. On the side horizontal beam subsystems, an upper portion is not fixed but rather attached near the top of the vertical support system's inner most section. As they are raised, this upper portion of the horizontal beam subsystems pulls the curtain up with it.

When a control-initiation level is detected by sensors, as determined by a control system's microcontroller, all the vertical support subsystems are raised, concurrently, from a fully retracted position.

As the telescoping support subsystems reach their programmed height, the side curtains attached near the tops of the top-most vertical support subsystems, will be unrolled into position, protecting both sides.

When the vertical support subsystems are raised to predetermined height limits, the rear/roof/front curtain is deployed in position by first being pulled up, then over, then down.

When all curtains are in deployed positions, fully encompassing the dwelling, the control system initiates a valve-open command enabling water to enter the curtains.

At this time, the dwelling is surrounded on all sides and top by fire-resistant curtains, the curtains have water flowing within them, and perforations in the curtains allow air to flow through the curtains limiting the pressure created by wind-driven air against the curtain faces.

Sparks being driven against the curtains will extinguish well before causing the curtains to ignite. And, water flow within the curtains, will keep them cool as well as cool the air that passes through curtain-face perforations.

The following figures and descriptions are exemplary. They provide greater detail about the system, its subsystems, their structures and functions. An exemplary set of method steps provides more information about the sequence of steps from detection to deployment.

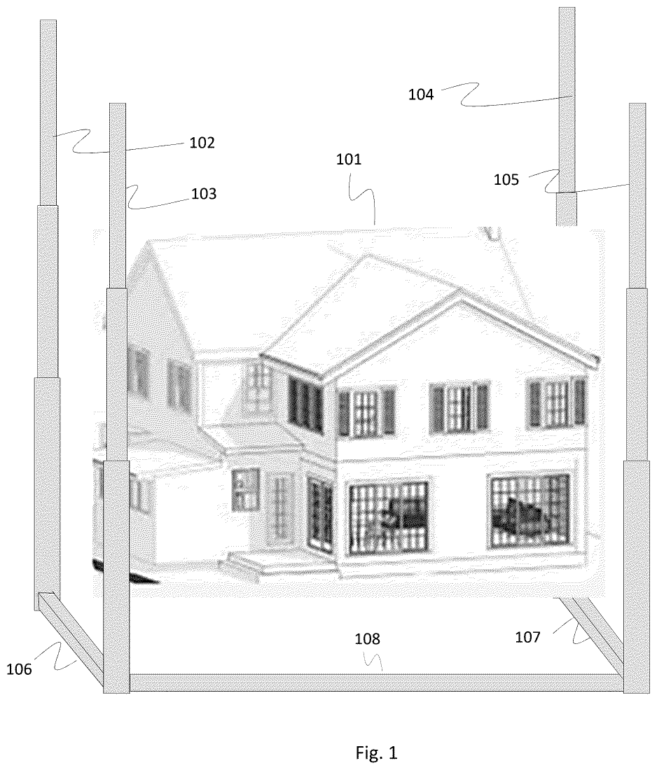

FIG. 1 shows the four vertical telescoping support subsystems (102, 103, 104 and 105); the two, side, horizontal beam subsystems (106 and 107); and the rear horizontal beam subsystem (108). The dwelling (101) is shown well within the aerial and elevation boundaries based on the positions of the vertical and horizontal structures.

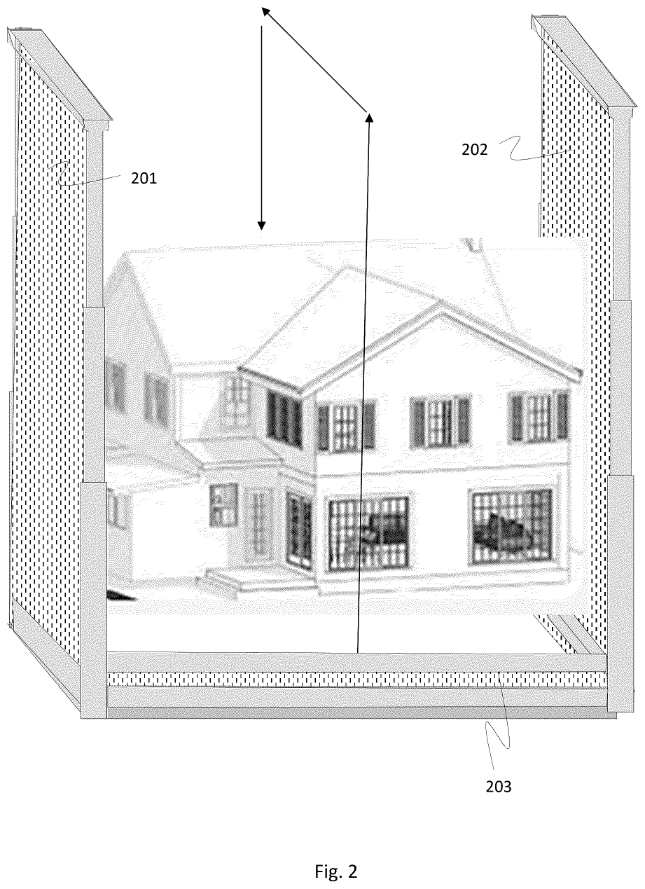

In FIG. 2, as shown, two side curtains (201 and 202) are first automatically deployed as the vertical support systems are extended upward, and the top portions of the horizontal beam subsystems are raised along with them. Afterward, a rear/roof/front curtain (203) is pulled up, over and down to provide protection for rear, roof and front of dwelling.

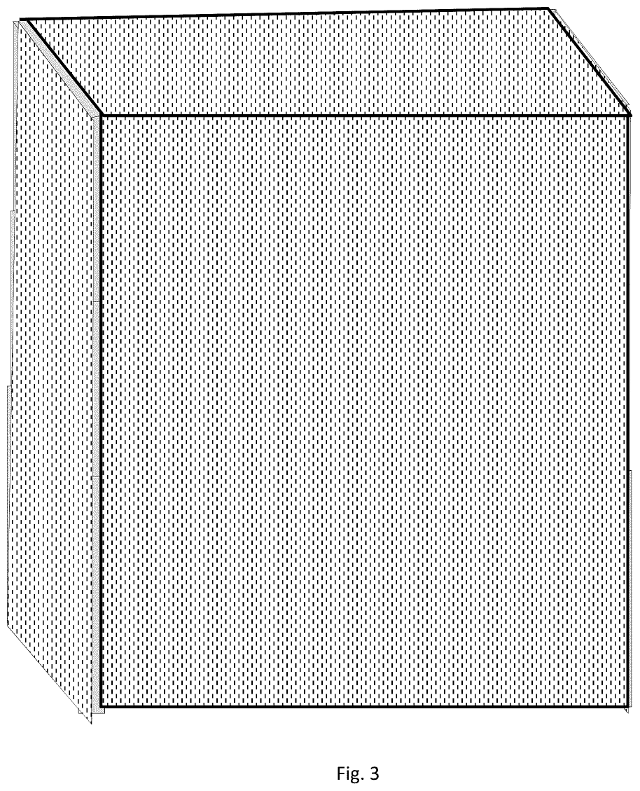

As shown in FIG. 3, once curtains are deployed, the curtains and support structures implement a box-like enclosure that encompasses the dwelling. One or more curtains may have zippered portals allowing entry or exit once deployed.

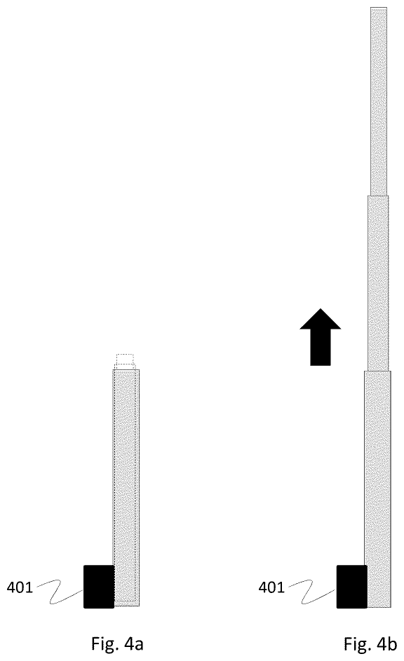

As shown in FIG. 4a, each of the four vertical, telescoping support subsystems are initially fully lowered; and after detecting a smoke and air temperature level that exceeds a predetermined limit, each of the four vertical, telescoping support subsystems ascends to programmed height, FIG. 4b. A support-raising subsystem (401) is operational to raise the inner sections of the telescoping support subsystem such that the sections now extend to a programmed height.

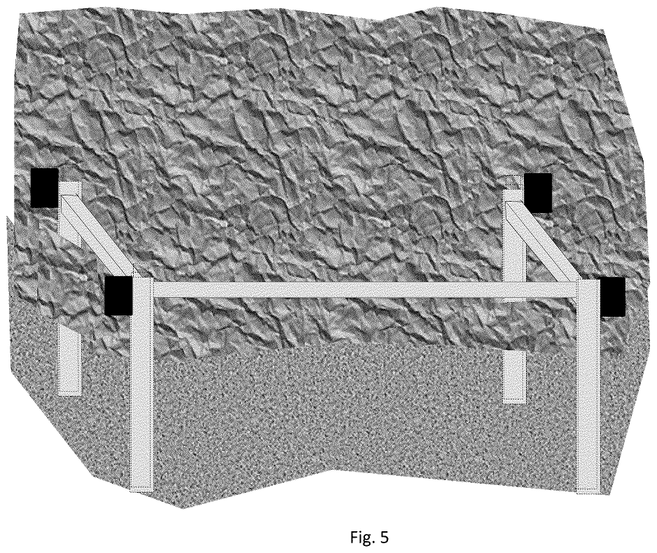

In FIG. 5, the widest section of the telescoping vertical support subsystem is essentially buried with just a small length protruding above the ground. At ground level, the support-raising subsystems (shown as black blocks) are essentially fixed at ground level. In this embodiment, the system is at or near ground level, when not deployed, and may be a preferred aesthetic installation.

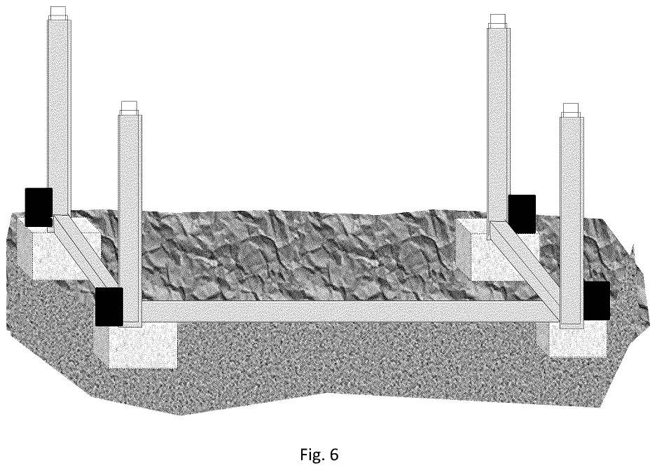

FIG. 6 shows another embodiment wherein the widest section of the telescoping vertical support subsystem is mounted such that its lowest portion is at or near ground level, and its highest portion is well above ground level. This may be less costly to install but may not be the preferred aesthetic installation.

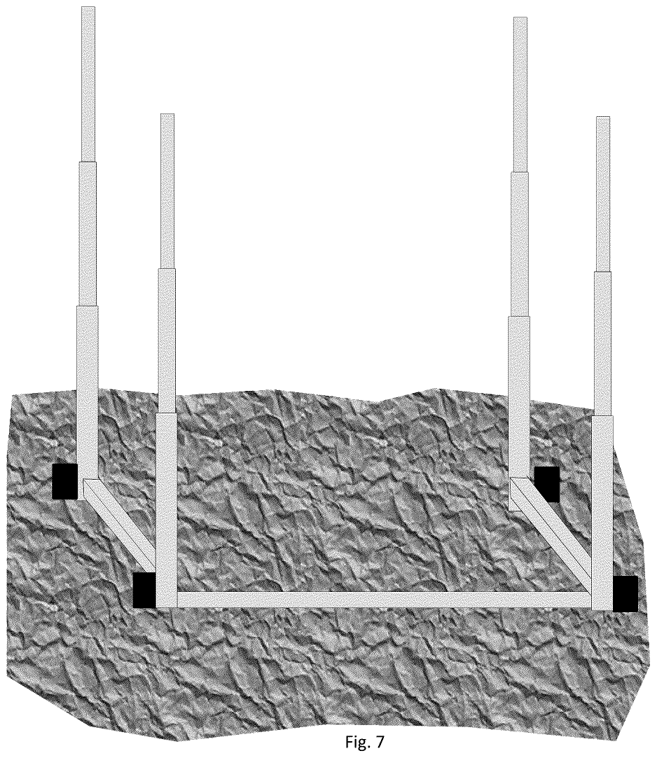

FIG. 7 shows an exemplary view of the system wherein the vertical support subsystems are extended to programmed height.

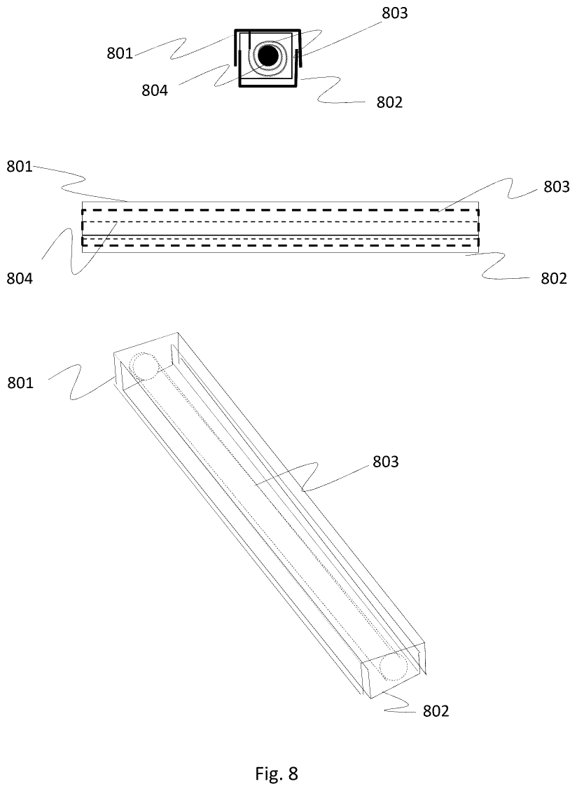

FIG. 8 shows an exemplary view of the structures of a horizontal beam subsystem. Each horizontal beam subsystem has an upper portion (801) and a lower portion (802). The lower portions as well as the rolled-up curtains (803) rolled up on a roller (804) are fixed in position with the lower portion of the horizontal beam subsystems. The upper portion of the two side horizontal beam subsystems are affixed near the top of the top-most section of the vertical support subsystems. As the latter rises, the upper portion rises with it, and the edges of the curtains affixed to the upper portion are pulled upward, automatically. FIG. 8 shows the structure from an edge-on view, a side view and a three-dimensional perspective.

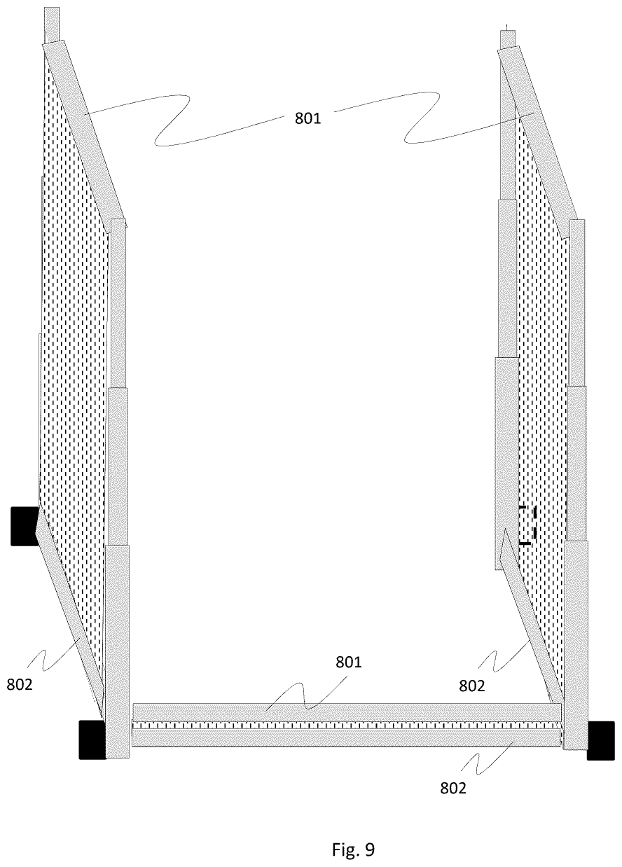

In FIG. 9, the side curtains, on rollers, are fixed in position near ground level by the lower portion (801), and their edges, attached to the top portion (801) are pulled upward as the vertical support subsystems are raised. The rear curtain, like the side curtains, is also fixed in position on its roller by its lower portion (802). When the curtain deployment subsystem is activated, it guides the top portion (801), on tracks, first up, then over, then down, completing the dwelling coverage.

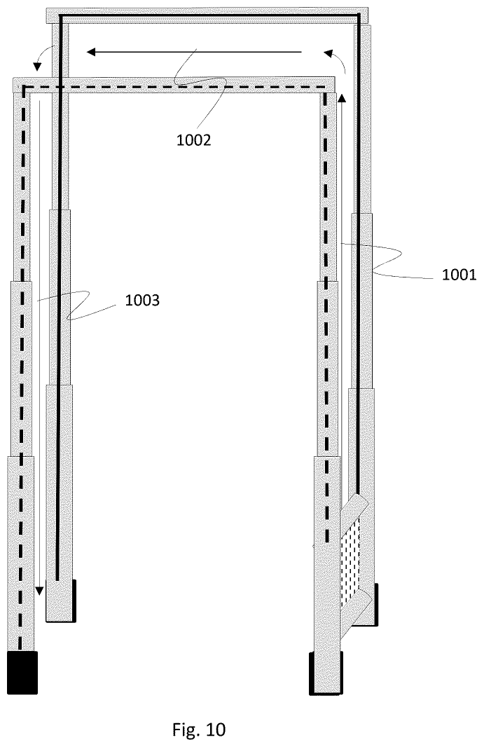

FIG. 10 is a view from the side showing the routing of the rear/roof/front curtain, contained in its horizontal beam subsystem as a deployment subsystem in the two, front, vertical support subsystem pull the curtain up (1001) from the rear horizontal beam subsystem, in which it resides, to first cover the rear, then the roof (1002), then front of the dwelling (1003).

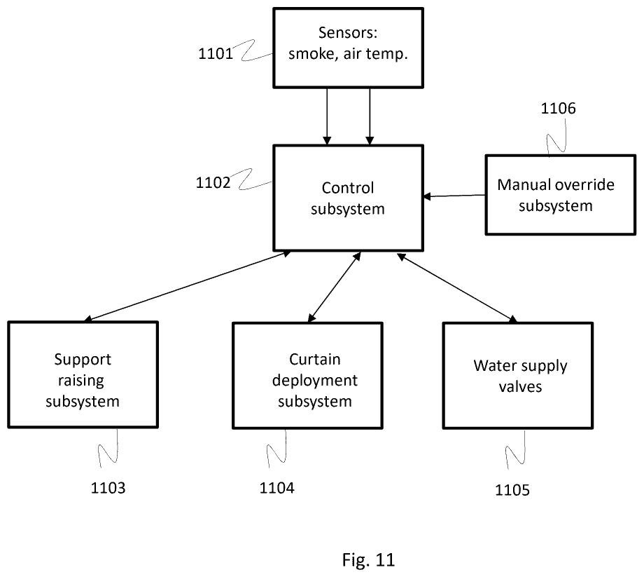

FIG. 11 shows an embodiment of the invention wherein sensors (1101) that detect and measure smoke level, and air temperature, convey the measurement data to a control subsystem (1102). The control subsystem compares sensor data to programmed, predetermined, upper limits. If the upper limits have not been exceeded, the system remains poised while continuing to monitor. Should the levels be exceeded, the control system will send commands to and receive positional feedback from the vertical subsystem motors (1103), curtain deployment subsystem (1104), and when the curtains are fully positioned, it will send a command and receive valve-state feedback from one or more water-supply valves (1105). There is, in addition, a manual override subsystem (1106) that can initiate operation independent of sensor readings. It could be a mobile-device app control, or a hand-held wireless device such as used to open and close a motorized garage door, or a switch conductively connected to the control system, like a keypad near a doorway.

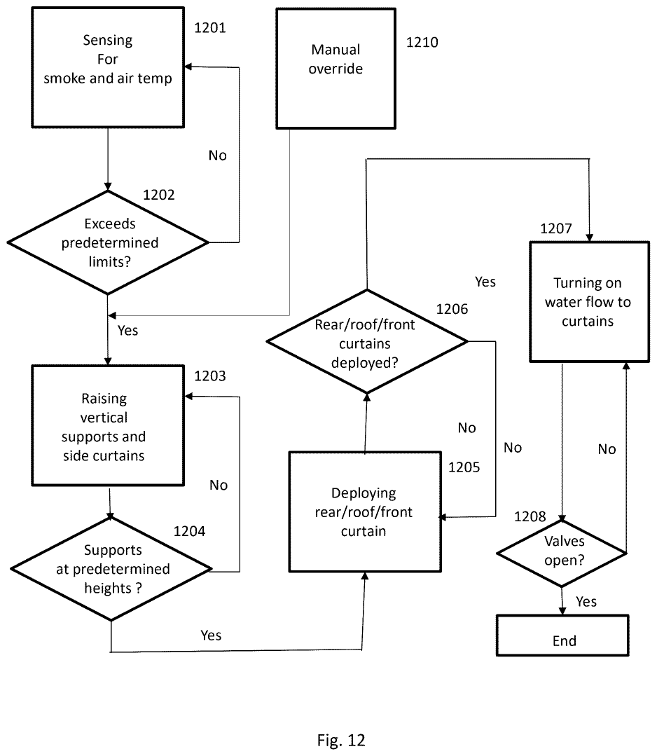

FIG. 12 is a method step flow diagram showing the sequence of operational method steps. The system's sensors are continuously monitoring smoke and air temperature and conveying that data to a control subsystem (1201). The control system receives the sensor data and compares it to programmed upper limits (1202). If the limits have not been exceeded, it remains poised while continuing to monitor. If the limits are exceeded, or if the manual override subsystem (1210) has been asserted, the control system is operative to control the raising of the vertical supports (1203). It will continue until the supports are all at predetermined heights (1204). Then, the control system is operative to begin the deployment of the rear/roof/front curtain (1205) and when it receives feedback that the rear/roof/front curtain is in position (1206), the control subsystem sends valve-open control commands (1207) and receives valve-state feedback (1208). At the end of the sequence of steps, the support subsystems have been raised, the curtains have been deployed, and the water flow is enabled.

The vertical telescoping support subsystems make use of interleaving sections of diminishing cross-sectional circumference that allow the smaller sections to smoothly be pulled into and locked into programmed height positions. The horizontal beam subsystems comprise rollers that support rolled-up curtains. Curtain deployment subsystem pull the rolled-up rear/roof/front curtain into position, whereas raising the vertical support subsystems automatically deploys the side curtains.

The curtains comprise fire-resistant material where the faces are perforated to allow air flow, and water flow is initiated by opening valves in the side and rear horizontal tubular subsystems.

The number of support systems is driven by the square footage of the dwelling. Ordinarily, only four vertical support systems are required, but larger dwellings may require intervening vertical support subsystems on side, rear and front.

Similarly, three horizontal beam subsystems will accommodate most dwellings, but larger footprints may require additional horizontal beam subsystems, curtains, and curtain deployment subsystems.

The vertical support subsystems may be extended to programmed-height using motor, pulley, cable assemblies. Alternatively, the interleaved telescoping sections could be outfitted with piston-ring like structures, significantly reducing leakage, and elevated into position using air pressure or hydraulics. Concerns about leakage over time are inconsequential if the sections are physically locked into extended position with automatically deployed locking fixtures.

The cross-sectional dimensions of the sections should allow smooth but firm telescoping. Preferred material would be aluminum or aluminum alloy. Wall thickness can be chosen such that a fully extended 30 feet, or higher, vertical support can sustain 80 mph winds without damage.

Telescoping towers and their raising/lowering subsystems are well-known in the art. Most are used for lighting or radio antennas. Using such structures for a dwelling protection system is believed to be novel. Using them to support fire-resistant curtains with water flow is believed to be novel.

These descriptions and drawings should not be read as limiting the claim scope.

What is claimed is:

1. A system comprising:
at least four, vertically oriented, telescoping support subsystems;
at least three, horizontally oriented, beam subsystems;
at least three fire-resistant curtain subsystems;
at least four curtain-attachment fixture subsystems;
a control subsystem;
at least two sensor subsystems, for smoke detection and measurement, and for air temperature measurement;
a manual-override subsystem;
one or more support-raising subsystems for the vertically oriented, telescoping support subsystems; and
one or more deployment subsystems for one fire-resistant curtain subsystem.

2. The system as in claim 1 wherein:
the at least four telescoping support subsystems comprise two or more interleaved telescoping sections.

3. The system as in claim 1 wherein:
the horizontally oriented, beam subsystems comprise an internal roller on which the fire-resistant curtain subsystems are rolled up prior to deployment.

4. The system as in claim 1 wherein:
the controller subsystem comprises:
a microcontroller subsystem;
non-volatile control memory storing at least one embedded control program;
read/write memory for sensor data and control data; and
an input/output subsystem.

5. A method comprising:
receiving data from a smoke detection sensor by a control subsystem;
receiving data from an air temperature measurement sensor by the control subsystem;
comparing data received from the smoke detection sensor with predetermined smoke control-initiation level;
comparing data received from the air temperature measurement sensor with predetermined air-temperature control-initiation level;
continuing to monitor smoke and air-temperature levels if level data is less than predetermined control-initiation level;
initiating control program execution if predetermined smoke and air-temperature control levels are exceeded;
initiating operation of all support subsystem support-raising subsystems;
continuing the support-raising operation until predetermined height is attained;
initiating, next, operation of curtain-deployment subsystem;
continuing the curtain-deployment operation until predetermined curtain positions are attained; and
initiating, next, opening of valves allowing water to flow through the curtain subsystems.

6. A method comprising:
receiving operation-initiation command from a manual override subsystem;
initiating the control program execution;
initiating the operation of all support-raising subsystems;
continuing the support-raising operation until predetermined height is attained;
initiating, next, the operation of curtain-deployment subsystem;
continuing the curtain deployment operation until predetermined curtain positions are attained; and
initiating, next, the opening of valves allowing water to flow through the curtain subsystems.
